(19) United States
(12) Patent Application Publication
(10) Pub. No.: US 2008/0140563 A1
(43) Pub. Date: Jun. 12, 2008

(54) METHOD AND SYSTEM FOR AUTOMATIC CONTROL OF CHATTEL AND ADMINISTRATION OF PAYMENT ON CHATTEL

(75) Inventors: Trent Richards, Roselle, IL (US); Amy Dunker Hersey, Richardson, TX (US); Wayne Wong, Houston, TX (US); Ashley Herndon, Irvine, CA (US)

Correspondence Address: FRANCISSEN PATENT LAW, P.C., 53 W. JACKSON BLVD, SUITE # 1320, CHICAGO, IL, 60604, US

(73) Assignee: My Car Payment, Inc., Roselle, IL (US)

(21) Appl. No.: 11/859,488

(22) Filed: Sep. 21, 2007

Related U.S. Application Data
(60) Provisional application No. 60/846,470, filed on Sep. 22, 2006.

(51) Int. Cl. G06Q 20/00

(52) U.S. Cl. 705/39

(57) ABSTRACT

A loan payment system for chattel includes a disabling unit that can disable the chattel. Receipt of an authorization code prevents the disabling unit from disabling the chattel. A debit server maintains data for users in possession of chattel that includes a communication address, an identifier for a lienholder, and an identifier for the disabling unit. A user tenders payment from a user account to the debit server, which verifies that the user's account has sufficient funds, debits the payment from the user's account, transfers the payment to an account for the lienholder, and requests the authorization code for the disabling unit provided on the user's chattel. A disabling unit server receives the request for the authorization code, determines the authorization code for the disabling unit, and sends the authorization code to the debit server, which sends the authorization code to the communication address.

### CROSS-REFERENCE TO RELATED PATENT APPLICATIONS

This patent application claims the benefit of U.S. Provisional Patent Application No. 60/846,470, filed Sep. 22, 2006 herein incorporated by reference in its entirety.

### FIELD OF THE INVENTION

This invention pertains to systems for control of chattel by a lienholder and management of payments and use of chattel by a debtor in possession of the chattel.

### BACKGROUND OF THE INVENTION

Systems have been introduced to interrupt the ignition system of an automobile on a regular, timed interval. To re-enable the car, a user is required return to a payment center, make a payment, and have an agent reset the interrupt mechanism for a renewed timed interval. The system can only be reset by an authorized agent as it requires a key held in escrow at the payment center. While the system is effective in encouraging customers to repay their auto loans in timely fashion, it has extreme overhead considerations. The system requires a customer to travel to the payment center each payment period of the loan. Of course, this prevents the user from taking extended travel without first making an advanced payment. In addition, a user must arrive at the payment center during the hours in which it is open. Still further, a user must wait to receive the attention of the agent. As these problems pose considerable inconvenience, these systems suffer from limited utility. It is desirable to automate the reset process so a user is not required to travel to a payment center.

More recently, starter interrupt systems have been developed that provide for a car to be disabled unless an activation code is entered to enable the vehicle to be started. An example of a starter interrupt system is described in U.S. Pat. Nos. 6,195,648; 6,717,527; 6,828,692; and 6,870,467.

In this example, the starter interrupt system includes an electronic apparatus coupled to the ignition system of an automobile. The electronic apparatus includes a mechanism whereby a user-operator is able to enter an activation code obtained from an agent of the payment center. Entry of a correct code serves as indication that a payment has been made and enables further use of the vehicle. On failure to timely make payments, a user is prevented from using the vehicle as the apparatus is arranged to disable the equipment by way of the ignition system to which it is coupled. Both a user-operator interface and starter interruption circuit are coupled to a logic processor that is easily mounted onto the vehicle subject to the program.

In this conventional system, a user who purchases a car from a dealer agrees to have the system installed on the purchased/financed automobile to protect the lienholder or lender from late payments on an outstanding debt. On initiation, parameters that relate to loan terms, for example, total number of payments and payment interval, are loaded into a system memory from a server unit. The logic processing unit computes a deadline time which corresponds to the due date and time for receipt of a payment. When a user makes a payment on time in agreement with loan terms, the payment agency releases a predetermined alpha-numeric code to the user. The user then enters the code via a user interface so that the logic processing unit can process the code for verification. If the code matches a reference code stored or generated within the device, then the logic processing unit puts the starter interruption circuit in a state which enables the car's starter system. A user who fails to make a payment will not receive the code necessary to unlock the system. If the user fails to enter the proper code by the time the deadline passes, the car is put into a disabled state by way of interruption of the starter until payment is made. Thus the logic processing unit is provided an indication that timely payment was made via receipt of a correct code.

In general, the method involved in this existing system includes computing a payment due deadline, generating a reference code which corresponds to the deadline, receiving a code at a logic processing unit, comparing the received code to the reference code, disabling a critical system if a correct code is not received before a present time exceeds a payment due deadline; enabling a critical system on receipt of correct code; and computing subsequent payment due deadline and generating a reference code which corresponds to the subsequent deadline.

### BRIEF SUMMARY OF THE INVENTION

In one exemplary embodiment, a system is provided that automatically accepts payment for a loan secured by a chattel, confirms the payment, and releases an authorization code to a user of the chattel. A debit server maintains a data store having data for each user in possession of a chattel provided with a disabling unit where the information includes at least a communication address for the user, an identifier for a lienholder, and an identifier for the disabling unit. A user sends a message to the server that tenders a payment related to the chattel and identifies a user account for funds for the payment. Responsive to the user's tendered payment, the server verifies that the user's account has sufficient funds for the payment tendered. If the user's account does not contain sufficient funds, the server sends a message to the communication address for the user notifying the user that the user account has insufficient funds. If the user's account does have sufficient funds, the debit server debits the payment from the account and transfers the payment to the lienholder's account. The debit server then sends a message to a disabling unit server requesting an authorization code and including the identification for the disabling unit provided on the user's chattel. The disabling unit server determines the authorization code for the requested disabling unit and sends it to the debit server. The debit server sends a message to the user's communication address that includes the authorization code, when an authorization is utilized. Alternatively, the message itself may provide the authorization.

### BRIEF DESCRIPTION OF THE DRAWINGS

FIG. 1 is a network architecture diagram illustrating one example of an embodiment of a system for automatic control of chattel and administration of payment on the chattel;

FIG. 2 is a network architecture diagram illustrating another example of an embodiment of a system for automatic control of chattel and administration of payment on the chattel; and

FIG. 3 is a network architecture diagram illustrating another example of an embodiment of a system for automatic control of chattel and administration of payment on the chattel.

### DETAILED DESCRIPTION OF THE INVENTION

In one example, the present invention involves installing a disabling unit 22 on a chattel 20, such as an automobile, a computer, a piece of construction equipment, or an appliance, that is subject to a loan secured by a lien on the chattel. Alternatively, the chattel may be subject to a lease or an insurance contract. The system described above is one example of a disabling unit suitable for an automobile or a piece of construction equipment. A computer may include a dongle capable of disabling the computer or an application program installed in the computer that may not be removed by the user and is configured to periodically prohibit the user from using the machine unless the user enters the authorization code. An appliance, such as a television or refrigerator, could also be provided with a disabling unit configured to prevent the appliance from operating after the expiration of a predetermined period of time unless a user inputs an authorization code via a user interface. Other disabling units may also be suitable beyond the examples listed here.

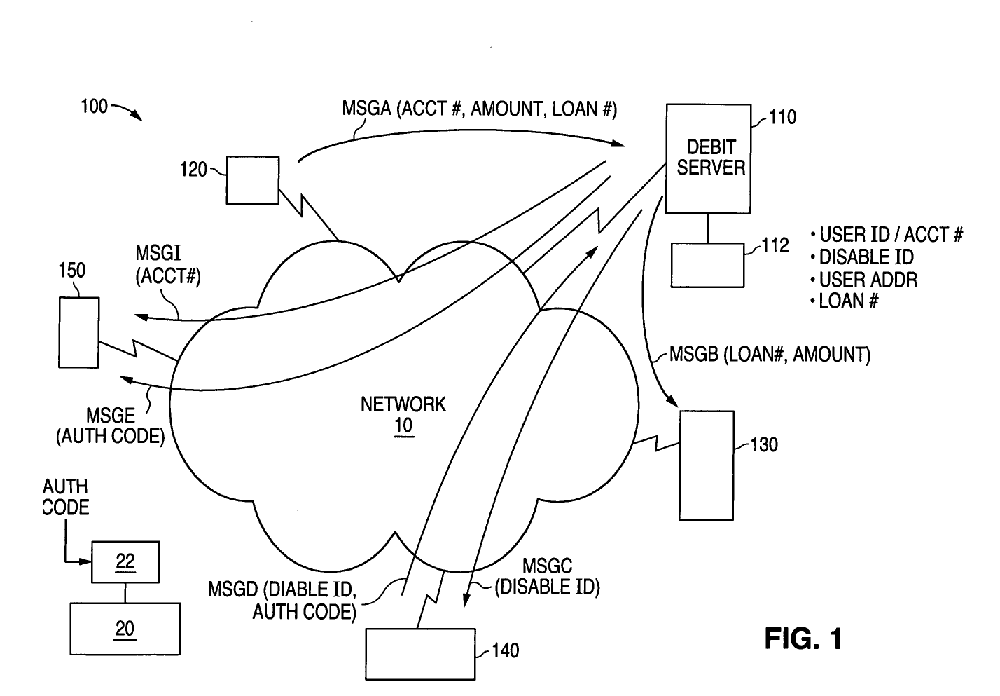

FIG. 1 is a network architecture diagram illustrating one example of an embodiment of a system 100 in accordance with the present invention. In system 100, a debit server 110 is in communication with a communication network 10. In system 100, a user who holds a chattel equipped with a disabling unit is registered with debit server 110, which maintains a data store 112 that includes for each registered user, a user identifier, a disabling unit identifier, a user communication address whereby server 110 may communicate with user through communication network 10, and a loan identifier. This is merely one exemplary embodiment and other embodiments may include more or fewer pieces of information for a registered user.

In the example of FIG. 1, a payment point device 120 is also in communication with network 10. A payment point device may be maintained by a payment center, such as a bank, a Western Union facility or a currency exchange. Other examples of devices that pay be used as payment point devices may include an automatic teller machine configured to receive payments, a credit or debit card reader and payment device, or an electronic fund transfer device. Other processing devices that may communicate via a network may be adapted to perform the function of electronically tendering payment on an account.

A lienholder server 130 is in communication with network 10 and maintains records of payments made on accounts, such as a loan, a lease or an insurance policy. In this example, the lienholder server 130 receives payments and maintains records for accounts secured by a registered user's chattel equipped with a disabling unit.

A disabling unit server 140 is in communication with network 10. The disabling unit server maintains records for a disabling unit on a registered user's chattel and is capable of generating an authorization code that, when entered into the disabling unit by a user, prevents the disabling unit from disabling the chattel for a predetermined time interval. At the end of the predetermined time interval, the disabling unit is configured to disable the chattel, e.g. by interrupting a starter circuit on a vehicle internally or with a GPS pager signal, unless an authorization code for a successive time interval is entered by the user. For example, a disabling unit in a user's chattel is configured to receive an authorization code and, responsive thereto, refrain from disabling the chattel for a corresponding month. An algorithm executing in both the disabling unit and disabling unit server 140 is able to generate the same authorization code for a given month, e.g. a pseudo random numeric value generated using a key value, a date value, and a known algorithm. A processor in the disabling unit calculates a new authorization code for the next payment cycle, e.g. next month, and disables the chattel unless it receives the new authorization code from the user via a user input device, e.g. a keypad. Alternatively, a communication link, e.g. a GPS or pager communication signal, is used to send an authorizing message to enable operation for the next payment cycle. An example of disabling unit system is described in the references discussed above.

In the embodiment of FIG. 1, a user communication device 150 is in communication with network 10 and corresponds to a registered user's communication address. For example, device 150 may be a mobile telephone, personal data appliance (PDA) or computer that can receive a message via voicemail, text messaging or electronic mail. Note that the user communication device 150 may, in some embodiments, be configured to perform the function of electronically tendering payment on an account as discussed above with respect to payment point device 120.

In one example of a scenario involving the system shown in FIG. 1, a registered user enters a bill payment center, presents a debit card, and, in this example, directs that payment be made on a loan corresponding to the registered user's chattel equipped with a disabling unit. The payment point device 120 sends a message MSGA to debit server 110 through network 10. MSGA includes the debit card account number, the payment amount, and the loan number. Alternatively, the debt account or loan number and payment amount may be directly correlated to the debit card account number, e.g. the debit card is dedicated to the user for the sole purpose of making a preset payment on a preset loan, in which case only the debit card account number need be provided in the message.

Upon receipt of MSGA, debit server 110 verifies whether sufficient funds are available in the debit card account to make the requested payment. If the debit card account contains insufficient funds, debit server 110 sends an insufficient funds message MSGI, which indicates that the account number provided lacks sufficient funds, to the user communication address that corresponds to the debit card account.

If the debit card account contains sufficient funds for the payment in MSGA, then debit server 110 transfers the payment funds from the debit card account to a lienholders account for the debt or loan. In this embodiment, debit server 110 sends a verification message MSGB to lienholder server 130 verifying payment has been made and identifying the debt account or loan number and the amount of the payment. Alternatively, debit server 110 maintains records of user payments and fund transfers and makes periodic reports to the lienholder server 130.

Once debit server 110 has verified and transferred the payment funds, it sends a message MSGC to disabling unit server 140 requesting an authorization code for, in this example, a disabling unit identifier associated with the debit account number. Disabling unit server 140 determines a current authorization code and sends the code to debit server 110 along with the disabling unit identifier. As noted above, in one embodiment, the disabling unit and server 140 perform a predetermined algorithm to calculate an authorization code. Other approaches may also be suitable for use with the present invention. For example, the authorization codes for a disabling unit may be predetermined and securely stored on the disabling unit, in a manner where the user cannot access the codes, and on server 140. In another example, server 140 has a secure communication link with the disabling unit, e.g. an encrypted messaging link, through which it transmits the authorization code. By way of another example, the authorizing message may be sent via GPS or pager signal unit installed in the chattel, e.g. a vehicle or appliance, to provide a communications interface. While the On-Time system described in the references discussed above is one embodiment for a disabling unit and server system suitable for use with the present invention, other embodiments will be apparent to those of ordinary skill in the art that do not depart from the teachings of the present invention.

When debit server 110 receives MSGD from disabling unit server 140, it obtains the user communication address corresponding to the disabling unit identifier from data store 112. Debit server 110 then sends message MSGE to the user communication address with the authorization code provided by server 140. In this example, the user communication address corresponds to user communication device 150. For example, device 150 is a PDA capable of receiving electronic mail and MSGE takes the form of an electronic mail message sent by debit server 110 to device 150 via network 10. In other examples, MSGE is a text message or a voicemail message. The user inputs the authorization code into disabling unit 22 in order to prevent chattel 20 from being disabled. Disabling unit 22 may be provided with a user interface, such as a keypad, to enable the user to input the authorization code.

In an alternative embodiment discussed above, the user may not have a communication address and messages MSGI and MSGE are sent to payment point device 120 and the information in the messages is conveyed to the user via an agent at the corresponding payment center. This approach may be preferred if the registered user does not have a communication device 150.

As noted above, while the example of FIG. 1 is discussed in the context of handling payments on a debt or loan secured by chattel, other types of accounts may be the subject of the present invention. For example, the chattel may be leased to the registered user, e.g. a leased appliance or vehicle, and the payments that are managed by the system are payments on the lease. In another example, the account is an insurance policy, e.g. chattel or automobile insurance (including liability or physical damage), and the payments that are managed are payments on the insurance policy. For instance, a registered user may obtain a lower insurance premium on the insurance of an automobile in return for installing the disabling unit on the automobile that prevents it from being operated if the user has not made necessary payments on the insurance policy. By way of another example, the registered user may have a record of driving a vehicle while uninsured and a state may require the installation of the disabling unit to force the user to maintain mandatory insurance coverage.

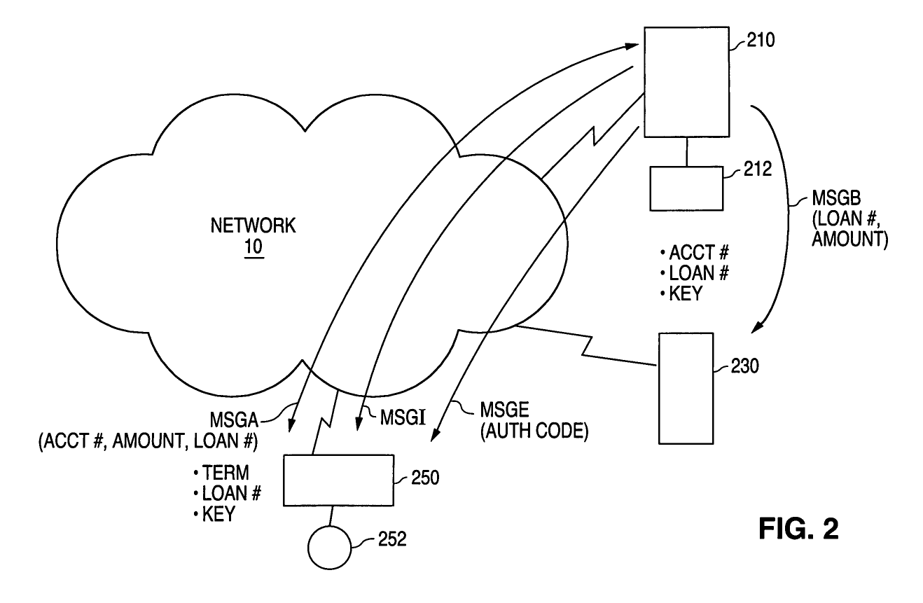

In the embodiment of FIG. 2, a user computer device 250 is in communication with network 10 along with debit and disablement server 210. In this example, user computer device 250 includes an authorization and disablement application 252 installed on the user computer device 250. Application 252 is capable of preventing a user from using the computer device until an authorization code is received from server 210. For example, the application may lock the user interface until a valid authorization code is input by the user as obtained in a manner similar to the scenario described in FIG. 1.

In the example described in FIG. 2, application 252 is configured to collect payment information from the user and transmit that information to debit and disablement server 210. Application 252 locks out the user until a valid authorization code is provided by server 210. Application 252, in this example, is configured to calculate the valid authorization code based on a secure key value, a predetermined algorithm, and a given term or time interval to which the authorization code applies, e.g. a given month. As noted above, there are other suitable approaches to providing the authorization code, such as by securely prestoring the values along with application 252 on device 250 or through public/private key sets, for example.

In this example, application 252 collects a debit account number from the user and sends message MSGA with the debit account number, amount of the payment, and the debit account or loan number. As noted above, it is possible to use more or fewer parameters than the ones described here and, as noted above, the debit account number may be sufficient in some embodiments. Device 250 sends message MSGA to server 210 via network 10. In a manner similar to the example discussed above regarding FIG. 1, server 210 determines whether the debit account number has sufficient funds to make the payment amount. If there are insufficient funds, then server 210 sends message MSGI to device 250 indicating insufficient funds and application 252 communicates this fact to the user via the user interface of device 250. If there are sufficient funds in the account, then server 210 transfers the funds to the account of a lienholder or loan holder and may send message MSGB to the lienholder's server 230 to verify the payment. Server 210, in this example, then calculates the authorization code based on a key value stored in store 212 that corresponds to application 252 in device 250. Server 210 sends message MSGE containing the authorization code to device 250. Application 252 compares the authorization code sent in message MSGE with the code calculated by application 252 and enables the user interface functionality for the user for the corresponding term of use. Alternatively, application 252 may have a secure communication link to server 210, e.g. an encrypted channel, that is inaccessible to the user of device 250, which application 252 uses to transmit the debit account information to server 210 and receive an authorization message from server 210.

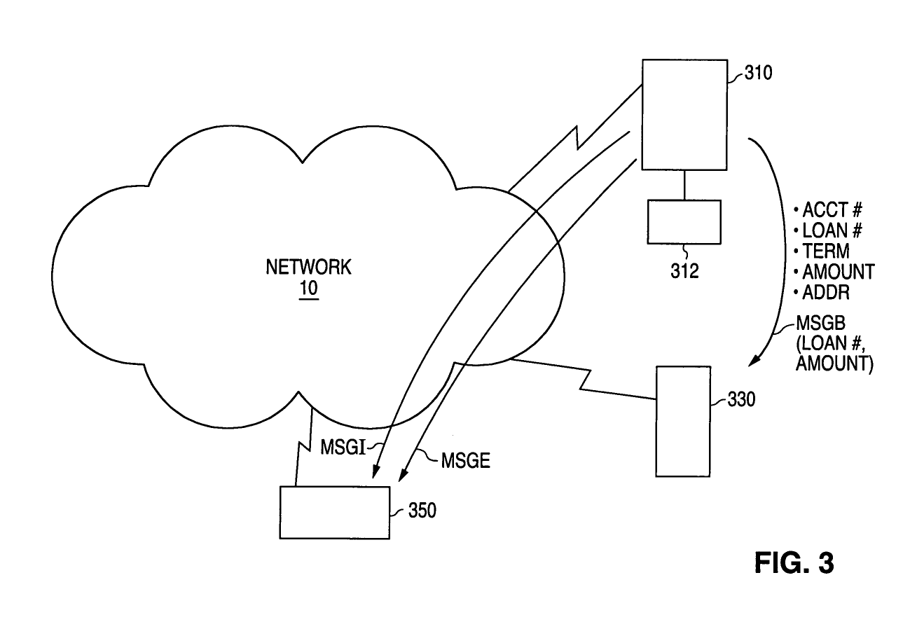

In the embodiment of FIG. 3, a control processor device 350 is in communication with network 10 along with debit server 310 and loan server 330. In this example, control processor device 350 is a part of the chattel that is capable of disabling the chattel from operating. For example, control processor device 350 may be an on-board computer on a vehicle that is configured to prevent the vehicle from operating if the control processor device 350 has not received an authorization message for a given term or time interval. For example, control processor device 350 may monitor the current date and, if the current month ends without control processor device 350 having received an authorization message, then control processor device 350 prevents the vehicle from operating. An example of a communication link for control processor device 350 to communicate with server 310 is the On-Star system currently provided in many General Motors vehicles.

In this example, debit server 310 is provided with data for a debit account number associated with a loan number, a term for the loan that indicates when payment is due, an amount for the term payment and a communication address for control processor device 350, which is stored in data store 312 when a user is registered. In this example, debit server 310 initiates a payment cycle by, for example, checking whether the debit account for a registered user contains sufficient funds for the amount of the payment within a predetermined time interval from the end of the current term, e.g. five days. If there are insufficient funds in the account, server 310 may send message MSGI indicating this status to control processor device 350 for display to the user via a user interface or display connected to device 350, for example. Alternatively, server 310 may send MSGI to a user communication address associated with the registered user, which would be stored in store 312 along with the other information associated with the debit account number.

If server 310 finds sufficient funds in the account corresponding to the debit account number, it transfers the payment amount to an account associated with the loan number and may send MSGB to loan server 330 verifying the payment on the loan number. Server 310 also sends MSGE to control processor device 350 indicating that the chattel may be operated for the corresponding term, e.g. the next month. Control processor device 350 responds to MSGE by allowing the chattel to operate for the corresponding term. As noted above, there are a variety of approaches for authorizing operation of the chattel and MSGE may take a variety of forms, such as a secure message, a message with a specific code, or an encrypted value.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A system for automatic acceptance of payment for a loan secured by a chattel, the system comprising:
a disabling unit for disabling operation of the chattel responsive to a predetermined event, where receipt of an authorization code in the disabling unit prevents the disabling unit from disabling the chattel;
a debit server configured to:
maintain data for each of a plurality of users in possession of chattel provided with a disabling unit, where the data for each user includes at least a communication address, an identifier for a lienholder, and an identifier for the disabling unit,
receive a message from a user that tenders a payment related to the chattel and identifies a user account for funds for the payment,
responsive to the user's tendered payment, verify that the user's account has sufficient funds for the payment tendered and, if the user's account does have sufficient funds for the payment tendered, debit the payment from the user's account, transfer the payment to an account for the lienholder, and send a message requesting the authorization code and including the identification for the disabling unit provided on the user's chattel, and
receive a message that includes the authorization code for the disabling unit and, responsive thereto, send a message to the communication address that includes the authorization code; and
a disabling unit server configured to receive the message requesting the authorization code and, responsive thereto, determine the authorization code corresponding to the identification for the disabling unit in the message and send the message to the debit server that includes the authorization code.

2. The system of claim 1, where:
the communication address corresponds to a communication device for the user; and
the disabling unit further includes a user interface for entering the authorization code.

3. The system of claim 1, where:
the communication address corresponds to a communication device for the user; and
the disabling unit is further configured to receive the message that includes the authorization code.

4. The system of claim 1, where the communication address corresponds to a communication device for the user.

5. The system of claim 1, where the communication address corresponds to a communication device for the user and the debit server is further configured to determine that the user's account does not contain sufficient funds and send a message to the communication address notifying the user that the user account has insufficient funds.

6. A method for automatic acceptance of payment for a loan secured by a chattel, the method comprising:
providing the chattel with a disabling unit for disabling operation of the chattel responsive to a predetermined event, where receipt of an authorization code in the disabling unit prevents the disabling unit from disabling the chattel;
providing a debit server that maintains a data store having data for each of a plurality of users in possession of chattel provided with a disabling unit, where the data for each user includes at least a communication address for the user, an identifier for a lienholder, and an identifier for the disabling unit;
sending a message from the user to the debit server that tenders a payment related to the chattel and identifies a user account for funds for the payment;
responsive to the user's tendered payment, verifying in the debit server that the user's account has sufficient funds for the payment tendered and, if the user's account does have sufficient funds for the payment tendered, debiting the payment from the user's account, transferring the payment to an account for the lienholder, and sending a message to a disabling unit server requesting the authorization code and including the identification for the disabling unit provided on the user's chattel;
responsive to the message requesting the authorization code, determining in the disabling unit server the authorization code corresponding to the identification for the disabling unit in the message and sending a message to the debit server that includes the authorization code;
responsive to the message that includes the authorization code, sending from the debit server a message to the user's communication address that includes the authorization code.

7. The method of claim 6, the method further comprising the steps of determining that the user's account does not contain sufficient funds and sending a message to the communication address for the user notifying the user that the user account has insufficient funds.

8. The method of claim 6, where the step of sending from the debit server a message to the user's communication address that includes the authorization code, includes sending the message that includes the authorization code to the disabling unit to prevent the disabling unit from disabling the chattel.

9. The method of claim 6, where the step of providing the chattel with a disabling unit for disabling operation of the chattel responsive to a predetermined event, where receipt of an authorization code in the disabling unit prevents the disabling unit from disabling the chattel further includes permitting the user to enter the authorization code into the disabling unit.

10. An automatic system for managing chattel, the automatic system comprising:
disabling means for disabling operation of the chattel responsive to a predetermined event, where receipt of an authorization code in the disabling means prevents the disabling means from disabling the chattel;
means for maintaining data for each of a plurality of users in possession of chattel provided with disabling means, where the data for each user includes at least a communication address for the user, an identifier for a lienholder, and an identifier for the disabling means;
means for receiving tender of payment from a user from a user account;
means for verifying that the user's account has sufficient funds for the payment in response to the tender of payment and, if the user's account does have sufficient funds for the payment tendered, debiting the payment from the user's account, transferring the payment to an account for the lienholder, and requesting the authorization code for the disabling means corresponding to the user's chattel;
means for determining the authorization code for the disabling means corresponding to the user's chattel responsive to the means for requesting the authorization code for the disabling means corresponding to the user's chattel and providing the authorization code to the disabling means.

11. The automatic system of claim 10, where the system includes:
means for sending a message to the user's communication address that includes the authorization code; and
means for entering the authorization code into the disabling means.

12. The automatic system of claim 10, where the system includes:
means for determining that the user's account does not contain sufficient funds; and
means for sending a message to the communication address for the user notifying the user that the user account has insufficient funds.
